(19) United States
(12) Patent Application Publication
(10) Pub. No.: US 2026/0244673 A1
(43) Pub. Date: Aug. 20, 2026

(54) IDENTIFYING RELATED PORTIONS OF ONE OR MORE DOCUMENTS

(71) Applicant: Dori Peleg, Kiryat Bialik (IL)

(72) Inventor: Dori Peleg, Kiryat Bialik (IL)

(21) Appl. No.: 19/054,471

(22) Filed: Feb. 14, 2025

(51) Int. Cl. G06F 16/35; G06F 40/205; G06F 40/30

(52) U.S. Cl. CPC G06F 16/35; G06F 40/205; G06F 40/30

(57) ABSTRACT

A processor-implemented method includes: accessing at least one document, where the at least one document includes at least one of: text, image, video, link to text, link to image, or link to video; processing the at least one document to identify a plurality of relations between portions of the least one document, where the processing includes applying at least one machine learning model to the at least one document; and generating a user interface configured to display the plurality of relations and to display corresponding portions of the at least one document corresponding to plurality of relations.

### TECHNICAL FIELD

The present disclosure relates to a document processing, and more particularly, to document processing for identifying related portions of one or more documents.

### BACKGROUND

Traditional approaches to document processing required programmers to manually implement software modules to perform desired tasks. This had been the paradigm for implementing computing tasks since the creation of computers. More recently, advancements in machine learning technology have provided an alternative approach to implementing certain aspects of computing tasks. For example, machine learning models may be trained using input and output data where the output data is known to be the result of the input data. During the training, machine learning models are able to configure their internal parameters to take the input data and to produce outputs that most closely approach or match the known output data. Such training occurs without requiring programmers to manually adjust the internal parameters of the machine learning models. The new paradigm of implementing computing tasks using machine learning models enables new processing systems that were not possible under the traditional approach.

### SUMMARY

The present disclosure relates to document processing for identifying related portions of one or more documents.

In accordance with aspects of the present disclosure, a processor-implemented method includes: accessing at least one document, where the at least one document includes at least one of: text, image, video, link to text, link to image, or link to video; processing the at least one document to identify a plurality of relations between portions of the least one document, where the processing includes applying at least one machine learning model to the at least one document; and generating a user interface configured to display the plurality of relations and to display corresponding portions of the at least one document corresponding to plurality of relations.

In various embodiments of the processor-implemented method, the plurality of relations include a first relation between a first corresponding portion of the at least one document and a second corresponding portion of the at least one document. The user interface is configured to display: the first corresponding portion of the at least one document, the second corresponding portion of the at least one document, and a first connection between the displayed first corresponding portion and the displayed second corresponding portion, where the first connection corresponds to the first relation.

In various embodiments of the processor-implemented method, the user interface is configured to display a plurality of other document portions connected to the first corresponding portion, and the plurality of other document portions have relations to the first corresponding portion that are different from the first relation.

In various embodiments of the processor-implemented method, the user interface is configured to display a plurality of other document portions connected to second corresponding portion, and the plurality of other document portions have relations to the second corresponding portion that are different from the first relation.

In various embodiments of the processor-implemented method, the user interface is further configured to display a first label indicating the first relation, and the first label is displayed adjacent to the displayed first connection.

In various embodiments of the processor-implemented method, the user interface is further configured to display: a third corresponding portion of the at least one document, a fourth corresponding portion of the at least one document, a second connection between the displayed first corresponding portion and the displayed third corresponding portion, and a third connection between the display second corresponding portion and the displayed fourth corresponding portion.

In various embodiments of the processor-implemented method, a relation corresponding to the second connection is same as the first relation corresponding to the first connection.

In various embodiments of the processor-implemented method, a second relation corresponding to the second connection is different from the first relation corresponding to the first connection.

In various embodiments of the processor-implemented method, the user interface is further configured to display a second label indicating the second relation, and the second label is displayed adjacent to the second connection.

In various embodiments of the processor-implemented method, a relation corresponding to the third connection is same as the first relation corresponding to the first connection.

In various embodiments of the processor-implemented method, a second relation corresponding to the third connection is different from the first relation corresponding to the first connection.

In various embodiments of the processor-implemented method, the user interface is further configured to display a second label indicating the second relation, and the second label is displayed adjacent to the third connection.

In various embodiments of the processor-implemented method, the user interface further includes at least one user interface element specifying at least one filter, where the at least one user interface element, when activated, causes the user interface to at least one of: display only relations, among the plurality of relations, which match the at least one filter, or display only relations, among the plurality of relations, which do not match the at least one filter.

In various embodiments of the processor-implemented method, the at least one filter includes at least one of: a filter specifying a semantic relation category, a filter specifying a referential relation category, a filter specifying a hierarchical relation, a filter specifying at least one section reference in the at least one document, or a filter specifying a relation label.

In various embodiments of the processor-implemented method, the at least one filter includes at least one of: a filter specifying a strength of a relation, or a filter specifying number of occurrences of a relation.

In various embodiments of the processor-implemented method, the filter specifying number of occurrences of a relation is provided by at least one of: a histogram user interface, or a heatmap user interface.

In various embodiments of the processor-implemented method, the displayed first corresponding portion is selectable by a user, and the processor-implemented method further includes: in response to a user selecting the display first corresponding portion: opening one document of the at least one document containing the first corresponding portion, and displaying at least a portion of the one document showing the first corresponding portion.

In various embodiments of the processor-implemented method, the processing the at least one document to identify the plurality of relations between portions of the least one document includes parsing the at least one document to identify document sections. The user interface further includes at least one user interface element for a user to manually specify a granularity level for the document sections.

In various embodiments of the processor-implemented method, the parsing the at least one document to identify document sections includes: identifying new lines in the at least one document; and identifying document sections based on the identified new lines and based on at least one rule specifying at least one criterion for whether or not a new line designates a new document section.

In various embodiments of the processor-implemented method, the processing the at least one document to identify the plurality of relations between portions of the least one document includes: applying a first machine learning model to parse the at least one document to identify document sections.

In various embodiments of the processor-implemented method, the machine learning model is a large language model.

In various embodiments of the processor-implemented method, each of the document sections includes at least one of: a sentence, a single paragraph, multiple paragraphs, a user defined document section, a page, multiple pages, or a range of pages.

In various embodiments of the processor-implemented method, the processing the at least one document to identify the plurality of relations between portions of the least one document further includes: converting each of the document sections into a respective representation; and comparing the representations corresponding to the document sections to identify the plurality of relations between portions of the least one document.

In various embodiments of the processor-implemented method, the representations include at least one of: numerical vector representations, or keyword representations.

In various embodiments of the processor-implemented method, the converting each of the document sections into a respective representation includes at least one of: converting a document section including an image into a numerical vector representation, converting a document section including a video into a numerical vector representation, or converting a document section including text into a numerical vector representation.

In various embodiments of the processor-implemented method, the comparing the representations corresponding to the document sections includes comparing numerical vector representations based on a distance metric.

In various embodiments of the processor-implemented method, the converting each of the document sections into a respective representation includes: converting a document section including text into a keyword representation.

In various embodiments of the processor-implemented method, the comparing the representations corresponding to the document sections includes comparing keyword representations based on at least one of the following: exact keyword match, or keyword synonym match.

In various embodiments of the processor-implemented method, the processing the at least one document to identify the plurality of relations between portions of the least one document further includes: comparing the document sections using a second machine learning model to identify the plurality of relations between portions of the least one document.

In aspects of the present disclosure, an apparatus includes at least one processor and at least one memory having instruction stored thereon. The instructions, when executed by the at least one processor, causes the apparatus to perform any one of the preceding methods.

In aspects of the present disclosure, a processor-readable medium includes instructions which, when executed by at least one processor of an apparatus, causes the apparatus to perform any one of the preceding methods.

Various aspects are described in the Examples section below, which is incorporated by reference into this section.

The details of one or more embodiments of the disclosure are set forth in the accompanying drawings and the description below. Other features, objects, and advantages of the techniques described in this disclosure will be apparent from the description and drawings, and from the claims.

### BRIEF DESCRIPTION OF THE DRAWINGS

A detailed description of embodiments of the disclosure will be made with reference to the accompanying drawings, wherein like numerals designate corresponding parts in the figures:

FIG. 1 is a diagram of an example of an online environment that includes user devices communicating with a communication platform system over a network, in accordance with aspects of the present disclosure;

FIG. 2 is a diagram of an example of a display screen of a user interface for uploading one more documents and viewing related portions of the one or more documents, in accordance with aspects of the present disclosure;

FIG. 3 is a diagram of an example of a display screen of a user interface for viewing an identified portion of a document within the document, in accordance with aspects of the present disclosure;

FIG. 4 is a diagram of a portion of the user interfaces of FIG. 2 and FIG. 3 showing various information and user interface elements, in accordance with aspects of the present disclosure;

FIG. 5 is a diagram of a histogram user interface for selecting one or more relations to be displayed, in accordance with aspects of the present disclosure;

FIG. 6 is a diagram of a heatmap user interface for selecting one or more relations to be displayed, in accordance with aspects of the present disclosure;

FIG. 7 is a diagram of various types of hierarchical relations for connections, in accordance with aspects of the present disclosure;

FIG. 8 is a diagram of an example of an operation for identifying related portions of one or more documents, in accordance with aspects of the present disclosure;

FIG. 9 is a diagram of an example of an operation for identifying related portions of one or more documents based on representations of document sections, in accordance with aspects of the present disclosure;

FIG. 10 is a diagram of an example of a keyword representation of portions of a document, in accordance with aspects of the present disclosure;

FIG. 11 is a diagram of an example of an operation for identifying related portions of one or more documents using a machine learning model, in accordance with aspects of the present disclosure; and

FIG. 12 is a block diagram of an example of components of a system, in accordance with aspects of the present disclosure.

### DETAILED DESCRIPTION

The present disclosure relates to document processing for identifying related portions of one or more documents. In aspects of the present disclosure, machine learning models are implemented to identify related portions of one or more documents.

In the following description, certain specific details are set forth in order to provide a thorough understanding of disclosed aspects. However, one skilled in the relevant art will recognize that aspects may be practiced without one or more of these specific details or with other methods, components, materials, etc. In other instances, well-known structures associated with transmitters, receivers, or transceivers have not been shown or described in detail to avoid unnecessarily obscuring descriptions of the aspects.

Reference throughout this specification to “one aspect” or “an aspect” means that a particular feature, structure, or characteristic described in connection with the aspect is included in at least one aspect. Thus, the appearances of the phrases “in one aspect” or “in an aspect” in various places throughout this specification are not necessarily all referring to the same aspect. Furthermore, the particular features, structures, or characteristics may be combined in any suitable manner in one or more aspects.

As used herein, the term “document” refers to any electronic file in any format, including, without limitation, PDF files, Microsoft Word file, Google Docs file, text files, image files (e.g., JPG, TIFF, etc.), video files (e.g., MP4, MOV, etc.), a presentation file (e.g., Microsoft PowerPoint), or any other electronic file.

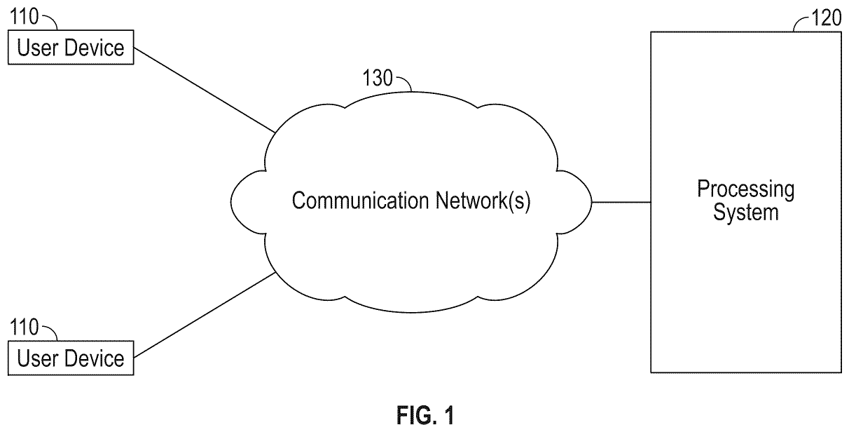

Referring to FIG. 1, there is shown a diagram depicting an online environment that includes user devices 110 communicating with a processing system 120 over one or more communication network(s) 130. The user devices 110 include a software app (not shown), which may be a dedicated app, a native app, or a web browser, that can communicating with the processing system 120. In various embodiments, the user device 110 can be a smartphone, a tablet, a laptop, a desktop computer, or another type of user device. As persons skilled in the art will understand, a user device 110 includes many components. Such components are not illustrated in FIG. 1 to provide a clearer illustration. Such other components can include, for example, a processor, memory, a display screen, an electronic storage, a networking transceiver (e.g., Wi-Fi, Ethernet), a user interface, a power source, an operating system (e.g., iOS, Android, Windows), a GPS (Global Positioning System) receiver, and/or other components which persons skilled in the art will recognize. Various user interfaces of the software app will be described in more detail below. For now, it is sufficient to note that the software app enables display screens which display related portions of one or more documents.

The processing system 120 may be or include a cloud system, a standalone system, and/or a combination of a cloud system and a standalone system, among other possibilities. As persons skilled in the art will understand, a processing system 120 includes many components, and such components are not all illustrated in FIG. 1 to provide a clearer illustration. Such other components can include, for example, one or more processors, memory, electronic storage, a networking transceiver(s) (e.g., Wi-Fi, Ethernet), a user interface, a power source, an operating system (e.g., iOS, Windows), and/or other components which persons skilled in the art will recognize. The processing system 120 also includes software and data that provide display screens, which will be described in more detail below herein.

The communication network(s) 130 convey information between the user devices 110 and the processing system 120. The network(s) 130 represent a communication path between the user devices 110 and the processing system 120 and can span one or more types of networks, including, for example, a cellular network, a data communications network (e.g., Internet backbone), and a PSTN (public switched telephone network), among others. Persons skilled in the art will understand such portions of the communications path, and they are not illustrated separately or in detail in FIG. 1. As an example, the user device 110 may be a smartphone that is connected to a cellular network. The cellular network is then physically connected to the Internet backbone. The processing system 120 may be connected to the Internet backbone through data connections such as optical fiber, through telecommunication connections such as Ethernet cables, and/or through satellite connections such as VSAT ground stations, among other things. All such network components, protocols, and connections are contemplated to be within the scope of the network(s) 130.

The illustration of FIG. 1 is merely an example, and variations are contemplated to be within the scope of the present disclosure. For example, the processing system 120 may be implemented by more than one machine and may be geographically distributed. In various embodiments, the processing system 120 may be implemented as a proprietary system that can be accessed over an intranet, a local network, and/or a virtual private network. Such and other variations are contemplated to be within the scope of the present disclosure.

The following will describe examples of display screens. As described above, the display screens are displayed on a user device (e.g., 110, FIG. 1). In embodiments where the software app of the user device is a dedicated app or native app, all or portions of the display screens may be installed on the user device and may be populated with data provided by the processing system (e.g., 120, FIG. 1). In embodiments where the software app of the user device is an Internet browser, all or portions of the display screens may be provided by the processing system and may be populated with data provided by the processing system.

The display screens provide user interfaces for interfacing with a processing system that identifies related portions of one or more documents. The display screens are merely examples. Other display screens for presenting related portions of one or more documents are contemplated to be within the scope of the present disclosure.

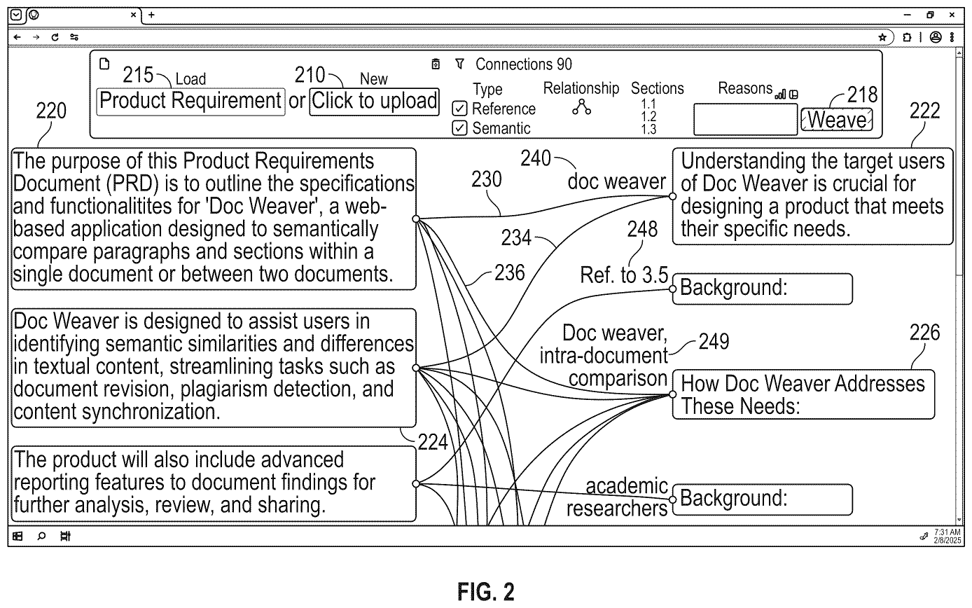

Referring now to FIG. 2, there is shown a diagram of an example of a display screen of a user interface for uploading one or more documents and viewing portions of the document(s) that are identified as related to each other. The example display screen shows a portion of the processing results. A user may scroll their display screen to view other portions of the processing results. Some or all of the settings and/or information may be stored in a processing system (e.g., 120, FIG. 1), and some of the setting and/or information may be stored in a user device (e.g. 110, FIG. 1).

The display screen includes a user interface element 210 for uploading one or more new documents to be processed. The display screen may optionally include a user interface element 215 for loading one or more documents that were previously uploaded. In accordance with aspects of the present disclosure, uploading one or more documents and engaging the “weave” user interface element 218 causes the processing system (e.g., 120, FIG. 1) to process the one or more documents to identify related portions of the one or more documents. In embodiments, the processing system may store the processing results so that if the one or more documents are loaded again (e.g., via user interface element 215), the stored processing results may be retrieved and displayed. In embodiments, after loading one or more documents via the user interface element 215, engaging the “weave” user interface element 218 causes the processing system (e.g., 120, FIG. 1) to process the one or more documents again to identify related portions of the one or more documents.

An example of the displayed processing results is shown in FIG. 2, which includes portions of the one or more documents which were identified by the processing, such as document portions 220, 222, 224, 226. The document portions are connected by various connections, such as connections 230, 234, 236. Connection 230 indicates that document portion 220 is related to document portion 222. Connection 234 indicates that document portion 224 is related to document portion 222. Connection 236 indicates that document portion 220 is related to document portion 226. Other document portions and connections from the processing results are shown in FIG. 2, as well. The visual presentation of the related document portions and their connections helps a user better understand the relations within the one or more documents and also the extent of relations. For example, the displayed results allows a user to better understand that some document portions, such as document portions 220 and 224, are related to multiple other portions of the document(s).

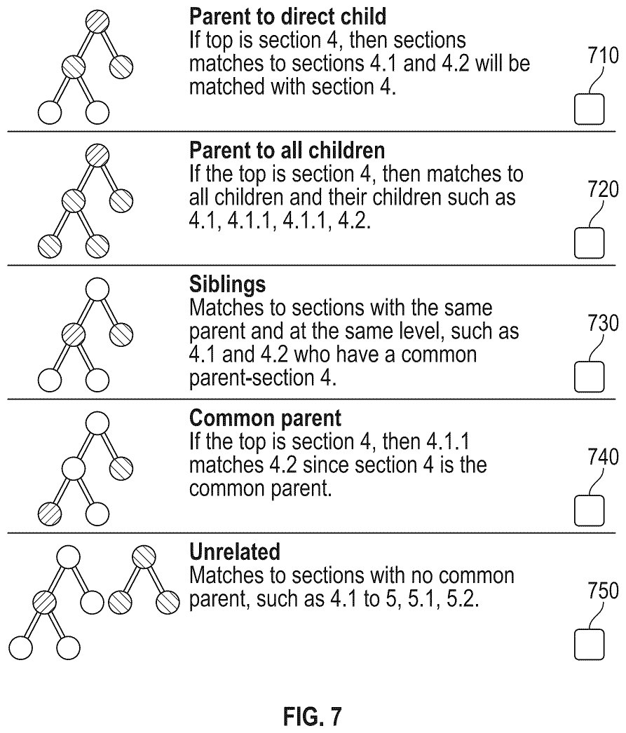

In accordance with aspects of the present disclosure, the user interface displays a label that reflects the relation for a connection. For example, the label “doc weaver” 240 reflects that connection 230 and connection 234 were identified based on the term “doc weaver” in document portions 220, 222, and 224. The relation indicated by label 240 is referred to herein as a “semantic relation,” which refers to a relation that is based on the meaning of the document portions. Another type of relation identified by the processing system is a “referential relation,” which refers to a relation that is based on one document portion referencing another document portion by, e.g., section number, paragraph number, section heading, intra-document comparison, inter-document comparison, or another type of reference. An example of a label that reflects a referential relation is the label 248, which states “Ref to 3.5” to indicate that one document portion referred to another document portion appearing at “3.5” (which may be, for example, a section number). Another example is label 249, which states “intra-document comparison.” Other labels are also shown in FIG. 2 to indicate the relations for various connections. A further type of relation is a “hierarchical relation,” which refers to a relation between different numbered sections of a hierarchically numbered document. Examples of hierarchical relations are shown in and will be described in connection with FIG. 7 below. A benefit of the labels is they allow a user to understand the nature of the relations and the extent of various relations. For example, a user can understand that some portions of the document(s), such as document portion 226, are related to other document portions in different ways. As another example, a user viewing the labels can understand that many document portions are related to each other by the relation “doc weaver.” The types of labels and the relations they indicate are merely examples, and other relations and labels are contemplated to be within the scope of the present disclosure.

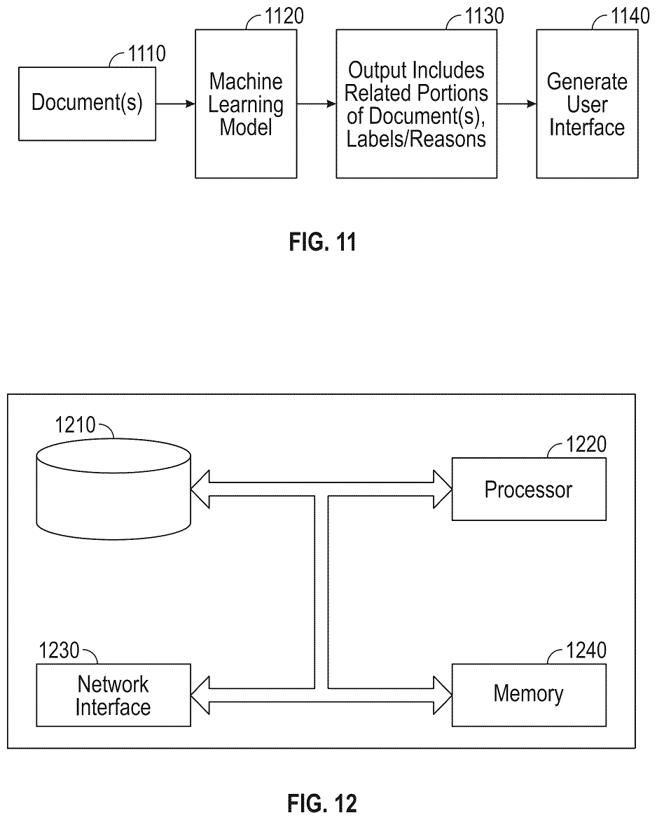

In aspects of the present disclosure, in addition to displaying labels for connections, the user interface may present to the user a fuller explanation of why two portions of the document are related. An example of a fuller description is provided in the description of FIG. 11 below, in the output of the machine learning model; in particular, the “Reason for connection” in the output of the machine learning model can be used as a fuller explanation of a relation/connection. In various embodiments, the user interface may display the fuller explanation when a user clicks, taps, or hovers a mouse pointer over a label or over a connection line. Other embodiments for when and where to display a fuller explanation are contemplated to be within the scope of the present disclosure.

Other portions of the user interface will be described later herein. FIG. 2 and the description above are merely examples, and variations are contemplated to be within the scope of the present disclosure.

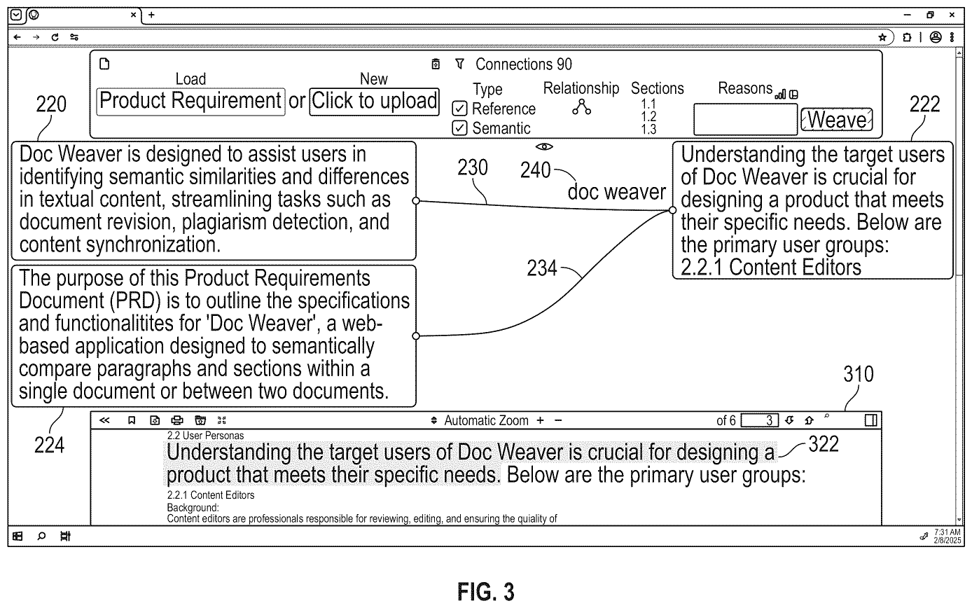

FIG. 3 is a diagram of an example of a display screen of a user interface for viewing an identified portion of a document within the document. In accordance with aspects of the present disclosure, the document portions identified and displayed, e.g., in the user interface of FIG. 2, may be selectable by a user. For example, a user may select document portion 222. In accordance with aspects of the present disclosure, when a user selects a document portion, the connection(s) for the selected document portion, the label(s) for such connection(s), and the document portions related to the selected document portion, remain displayed in the user interface, while other document portions and connections that are unrelated to the selected document portion may no longer be displayed. For example, if a user selects document portion 222, then connections 230, 234, label 240, and related document portions 220, 224, remain displayed in the user interface, while other connections and document portions that are unrelated to the selected document portion 222 are no longer displayed in the user interface.

In accordance with aspects of the present disclosure, in response to a user selecting a displayed document portion, the user interface may open a display 310 of the document containing the selected document portion and show the portion 322 of the document containing the selected document portion. For example, in the example of FIG. 3, the user interface accessed the document containing the selected document portion 222 in an embedded document plugin 310 and scrolled to the portion 322 of the document containing the selected document portion 222. In embodiments, the user interface may highlight the selected document portion 222 in the display 322 of the document. In this manner, a user may easily review the context of selected document portion by reviewing the text surrounding the selected document portion in the document.

FIG. 3 and the description above are merely examples, and variations are contemplated to be within the scope of the present disclosure.

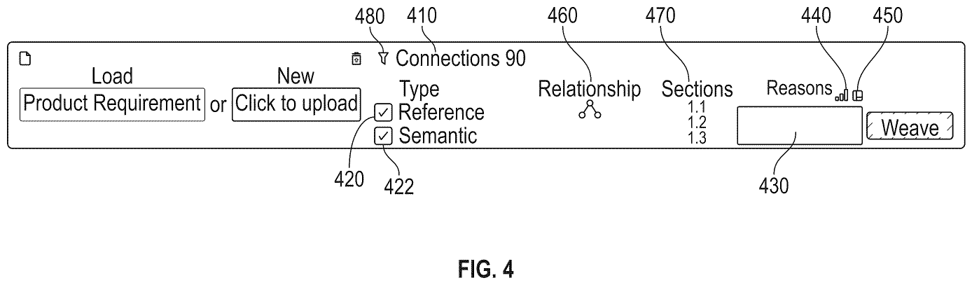

FIG. 4 shows a portion of the user interfaces of FIG. 2 and FIG. 3 showing various information and user interface elements, which will now be described. The user interface includes a display element 410 showing number of connections, which may be either the total number of connections in the processing results or the number of connections resulting from various filters. In the illustrated example, the number of connections is shown as ninety (90) connections.

In accordance with aspects of the present disclosure, the user interface includes user interface elements 420, 422, such as a checkboxes, that serve as filters for a user to indicate type(s) of relations to display. In the illustrated user interface, one user interface element 420 (e.g., checkbox) can be selected to indicate that all referential relations are to be displayed, and another user interface element 422 (e.g., checkbox) can be selected to indicate that all semantic relations are to be displayed. In the example of FIG. 4, both are selected, so that all referential relations and all semantic relations are to be displayed. If only one is selected, then only the selected type of relation would be displayed, and as a result, the number of connections shown in the display element 410 may decrease. Other types of relations are contemplated, and additional user interface elements may be directed to such relations to indicate that such relations are to be displayed or not displayed. In various embodiments, the user interface element(s) serve as a filter to indicate what is not to be displayed, such that selection of a user interface element may indicate that a type of relation should not be displayed.

In accordance with aspects of the present disclosure, the user interface may include a user interface element 430, such as a text box or a pull-down interface, that serves as a filter for the labels (e.g., label 240, 248, 249) described in connection with FIG. 2. When a user enters or selects one or more labels, the user interface may display only connections corresponding to such labels. Because labels reflect the reasons that a connection was identified, the selection of a label is equivalent to selection of reasons for various connection being identified. Accordingly, a user is, in effect, indicating which connection reasons are to be displayed. In various embodiments, the user interface element 430 serves as a filter to indicate what is not to be displayed, such that the entry or selection of labels/reasons may indicate that connections corresponding to the label/reasons should not be displayed.

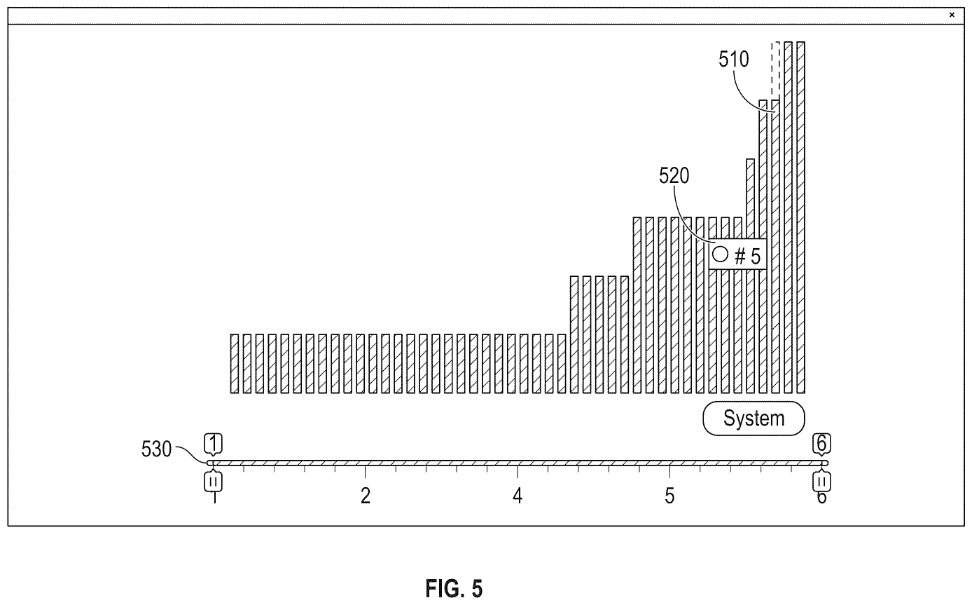

In aspects of the present disclosure, the user interface may include a user interface element 440 which, when engaged, displays a histogram of labels/reasons for connections, from which a user may view a distribution of labels/reasons for connections and select one or more labels/reasons to be displayed. An example of such a histogram will be described in connection with FIG. 5.

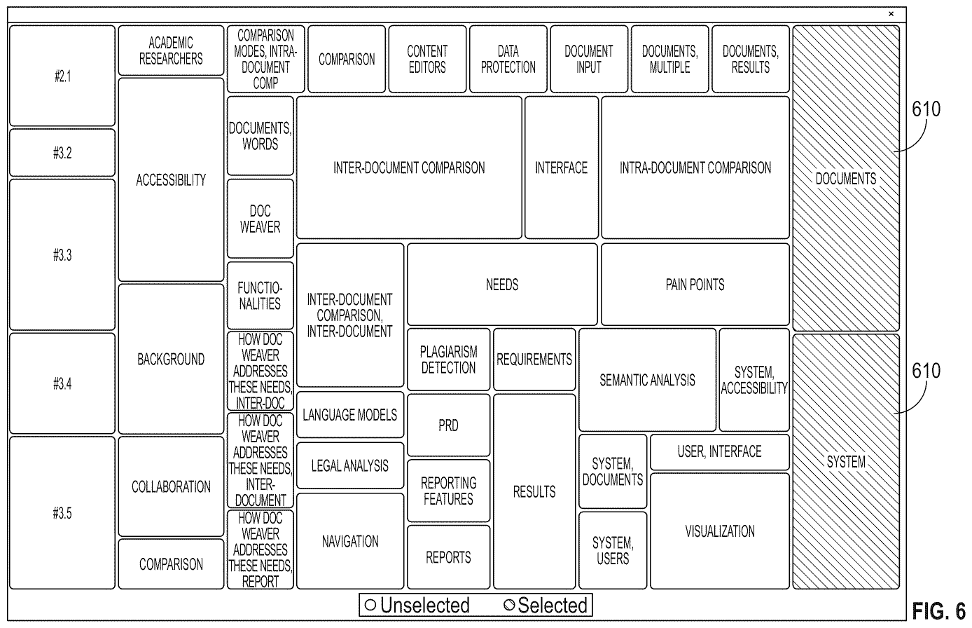

In aspects of the present disclosure, the user interface may include a user interface element 450 which, when engaged, displays a heatmap of labels/reasons for connections, from which a user may view a heatmap of labels/reasons for connections and select one or more labels/reasons to be displayed. An example of such a heatmap will be described in connection with FIG. 6.

In aspects of the present disclosure, the user interface may include a user interface element 460 which, when engaged, displays various types of hierarchical relations for connections, from which a user may view the different types of hierarchical relations and select one or more types of hierarchical relations for which connections are to be displayed. Examples of such types of hierarchical relations will be described in connection with FIG. 7.

In aspects of the present disclosure, the user interface may include a user interface element 470 which, when engaged, displays a list of numerical referential relations identified by the connections, from which a user may select one or more of the numerical referential relations for which connections are be displayed. In embodiments, the user interface element 470 can be a list interface that is populated by section numbers in the document. A user may select any number of items in the list interface. For example, assuming the document includes sections 2, 2.1, 2.1.1, 2.1.2, 2.2, etc., if a user selects item “2” in the list interface, the selection may be treated as automatically selecting all children of section 2. Any item in the list interface may be selected or unselected by a user, and any number of items in the list interface may be selected. All connections corresponding to selected items in the list interface will be displayed, including all related portions for such connections, and other connections not corresponding to the selected items in the list interface will not be displayed.

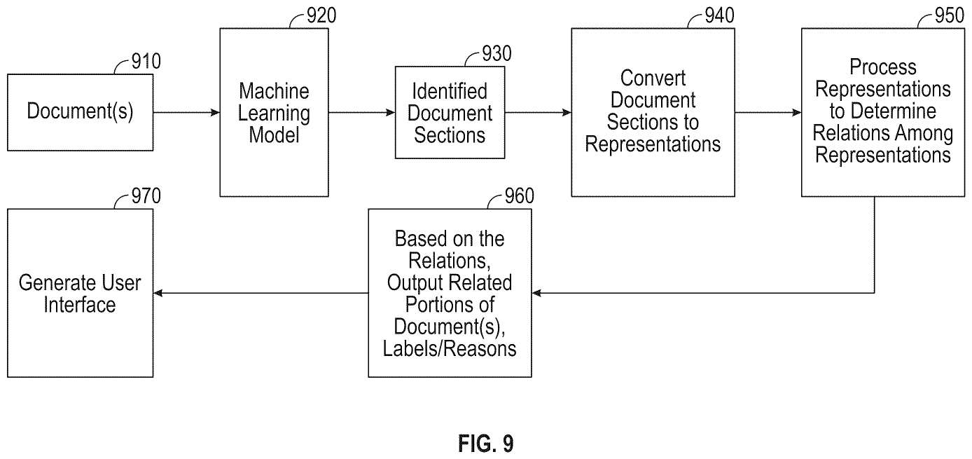

In aspects of the present disclosure, the user interface may include a user interface element 480 which, when engaged, displays various other filters that can be activated. A filter, for example, may relate to strength of relation. When such a filter is selected, connections which have a relation strength that exceeds a threshold may be displayed, while connections which have a relation strength below the threshold may not be displayed. In embodiments, the filter can use level of confidence of a connection identification algorithm (e.g., 950, FIG. 9) as strength of a relation. For example, for a connection identification algorithm based on vector representations of document portions, a distance metric may be used to determine distance between vectors and, thus, strength of a relation. As another example, for a connection identification algorithm based on keyword representations of document portions, an approach can measure vector representation of the keywords (e.g., using word2vec) and filter by the resulting angle. As another example for keywords, the filter can filter based on whether keywords are exactly the same (rather than a synonym) and keep only exact keyword matches but not synonyms. As another example for keywords, the filter can filter based on keywords that are synonyms or have similar meaning, and such a filter can be used in addition to or in place of exact keyword matches. Such and other embodiments are contemplated to be within the scope of the present disclosure.

FIG. 4 and the description above are merely examples, and variations are contemplated to be within the scope of the present disclosure.

FIG. 5 shows an example of a histogram user interface for selecting one or more relations to be displayed. In the histography user interface, each bar represents a label/reason in the relations identified by the document processing, and the height of the bar represents the number of connections having that label/reason. In the illustrated example, the number of connections reflected by the bars ranges from one to six. Any number of connections may be reflected in the histogram user interface.

In accordance with aspects of the present disclosure, a user may select any bar and/or select any number of bars in the histogram user interface, e.g., by tap, click, hover-over, etc. For example, a user may select bar 510. In embodiments, when a user selects a bar, an outline may be shown around the selected bar, such as the dashed outline shown in FIG. 5. Such an outline is merely an example, and other ways of indicating that a bar is selected are contemplated to be within the scope of the present disclosure. In aspects of the present disclosure, when a user selects a bar, such as bar 510, the user interface may display the number of connections 520 for the selected bar 510 and may display the label/reason corresponding to the selected bar 510. In various embodiments, the label/reason 410 may be displayed within its corresponding bar and may be displayed for a selected bar or may be displayed for each bar in the histogram user interface. Such and other variations are contemplated to be within the scope of the present disclosure.

In aspects of the present disclosure, the histogram user interface may include a user interface element 530 that allows a user to filter the histogram by number of occurrences. The user interface element 530 is shown in FIG. 5 as a sliding bar, but the user interface element 530 may be another type of interface element, such as checkboxes or a list interface, among other possibilities. A user may interact with the user interface element 530 to limit the displayed histogram to a subset of the number of occurrences.

The histogram user interface may be displayed in a pop-out dialog box, which may be displayed over a main user interface (e.g., FIG. 2). A user may make selections in the dialog box and may then close the dialog box to activate the selections and return to the main user interface (e.g., FIG. 2). In aspects, the histogram in the histogram user interface is ordered from lowest to highest number of occurrences, which intuitively matches with the filter bar 530. In various embodiments, the histogram may be ordered a different way. In various embodiments, horizontal bars, rather than vertical bars, may be displayed. Such and other variations are contemplated to be within the scope of the present disclosure.

FIG. 5 and the description above are merely examples, and variations are contemplated to be within the scope of the present disclosure.

FIG. 6 shows an example of a heatmap user interface for selecting one or more relations to be displayed. In the heatmap user interface, each box represents a label/reason in the relations identified by the document processing, and the size (or relative size) of the box reflects the number of connections having that label/reason. For example, a larger box reflects a larger number of connections having that label/reason, while a smaller box reflects a smaller number of connections having that label/reason. In various embodiments, the sizes of the boxes may be proportional. In various embodiments, the sizes of the boxes may not be proportional. In various embodiments, the boxes may include different colors or different shades (not shown) to reflect the number of connections corresponding to the boxes. For example, a darker shade may reflect a larger number of connections, while a lighter shade may reflect a smaller number of connection. Such and other variations are contemplated to be within the scope of the present disclosure.

In aspects of the present disclosure, the label/reason corresponding to each box may be displayed within the box, as shown in the example of FIG. 6. In embodiments, the label/reasons may be displayed in different font sizes to fit them within their respective boxes. In various embodiments, where there is insufficient room with a box to display the corresponding label/reason (e.g., a long label for a small box), the label may not be displayed in the box.

In various embodiments, when a user selects a box (e.g., by tap, click, hover-over, etc.), the label and number of connections for the box may be displayed in an enlarged box and/or may be displayed in another portion of the user interface outside the selected box. Such and other variations are contemplated to be within the scope of the present disclosure.

In aspect, a user may select any number of boxes in the heatmap user interface. In embodiments, selected boxes, such as boxes 610 in FIG. 6, may be displayed in a different color from unselected boxes, or may be visually presented in a different way from unselected boxes.

The heatmap user interface may be displayed in a pop-out dialog box, which may be displayed over a main user interface (e.g., FIG. 2). A user may make selections in the dialog box and may then close the dialog box to activate the selections and return to the main user interface (e.g., FIG. 2).

In aspects, rather than a heatmap using boxes, the user interface may instead display a word cloud diagram, in which the labels/reasons are shown in a word cloud in various orientations. In a word cloud, larger-sized words reflecting larger number of occurrences of the label/reason, while smaller-sized words reflecting smaller fewer number of occurrences of the label/reason. The various disclosure relating to a heatmap user interface are also applicable to a word cloud user interface.

FIG. 6 and the description above are merely examples, and variations are contemplated to be within the scope of the present disclosure.

FIG. 7 is a diagram of various types of hierarchical relations for connections. As described above, a hierarchical relation refers a relation between different numbered sections of a hierarchically numbered document. The following hierarchical relations are illustrated in FIG. 7.
“Parent to direct child” relation. For example, if a document has numbered sections 4, 4.1, 4.1.1, 4.1.2, and 4.2, then such a relation will determine that the document portion under section 4 (the parent) is related to the document portions under 4.1 and 4.2 (direct children).
“Parent to all children” relation. For example, if a document has numbered sections 4, 4.1, 4.1.1, 4.1.2, and 4.2, then such a relation will determine that the document portion under section 4 (the parent) is related to the document portions under 4.1, 4.1.1, 4.1.2, and 4.2 (all children)s.
“Siblings” relation. For example, if a document has numbered sections 4, 4.1, and 4.2, then such a relation will determine that the document portions under sections 4.1 and 4.2 (sibling) are related to each other, and also determine that the document portions under sections 4.1.1 and 4.1.2 (sibling) are related to each other. Generally, a sibling relation refers to, but may not be limited to, sections which have a common parent and are at the same level within a hierarchy.
“Common parent” relation. For example, if a document has numbered sections 4, 4.1, 4.1.1, 4.1.2, and 4.2, then such a relation will determine that the document portions under sections 4.1, 4.1.1, 4.1.2, and 4.2 are all related to each other because they all have a common parent, i.e., section 4.
“Unrelated”/“No common parent” relation. For example, if a document has numbered sections 4, 4.1, 4.1.1, 4.1.2, and 4.2, as well as 5, 5.1, and 5.2, then such a relation will determine that any of document portions under sections 4, 4.1, 4.1.1, 4.1.2, and 4.2 is related to any of document portions under sections 5, 5.1, and 5.2, under the “no common parent” relation.

The hierarchical relations shown in FIG. 7 are merely examples, and other hierarchical relations are contemplated to be within the scope of the present disclosure.

In accordance with aspects of the present disclosure, a user may select one or more hierarchical relations using user interface elements 710-750, e.g., checkboxes, to indicate that connections which satisfy the selected hierarchical relation(s) are to be displayed. In response to a user selecting one or more hierarchical relations, the user interface may display only the connection which satisfy the selected hierarchical relation(s). In various embodiments, the user interface elements 710-750 serve as filters to indicate what is not to be displayed, such that the selection of the user interface elements 710-750 may indicate that connections corresponding to the selected elements should not be displayed.

FIG. 7 and the description above are merely examples, and variations are contemplated to be within the scope of the present disclosure.

Accordingly, FIGS. 2-7 show various aspects of user interfaces of the disclosed technology. The user interfaces may be used by document creators and document readers. Document creators can use the user interfaces and disclosed technology to verify if the connections are what they intended or if there are missing connections. For creators of documents with a user defined separation into sections and subsections, one can use it to verify there are correct references between sections and subsections. For document readers, the standard approach is to search a document by keywords or semantic meaning, which does not convey connections within a document or between documents. Document readers can use the user interfaces and disclosed technology to read information and understand the connections within a document or between documents.

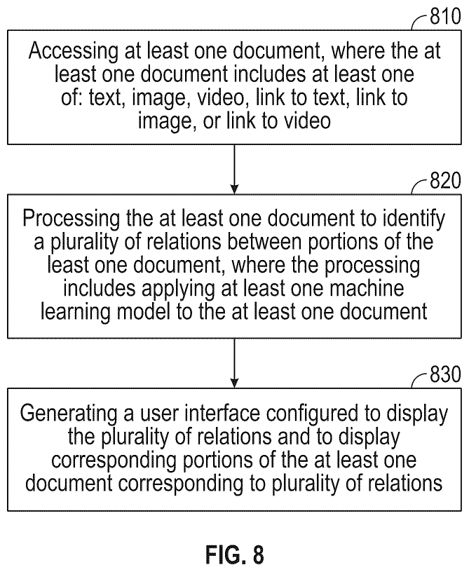

FIG. 8 is a flow diagram of an example of an operation for identifying related portions of one or more documents.

At block 810, the operation involves accessing at least one document, where the at least one document includes at least one of: text, image, video, link to text, link to image, or link to video. As described above, the term “document” refers to any electronic file in any format, including, without limitation, PDF files, Microsoft Word file, Google Docs file, text files, image files (e.g., JPG, TIFF, etc.), video files (e.g., MP4, MOV, etc.), presentation files (e.g., Microsoft PowerPoint), or any other electronic file. Any such document may include text, images, and/or videos, and/or may include links (e.g., hypertext links) to text, images, and/or videos.

At block 820, the operation involves processing the at least one document to identify a plurality of relations between portions of the least one document, where the processing includes applying at least one machine learning model to the at least one document. The plurality of relations may include any of the relations described above, including, without limitation, semantic relations, referential relations, and/or hierarchical relations. Further aspects of identifying such relations will be described below in connection with FIGS. 9-11.

At block 830, the operation involves generating a user interface configured to display the plurality of relations and to display corresponding portions of the at least one document corresponding to plurality of relations. The user interface include any aspects of the user interfaces described herein, including any shown or described in connection with any of FIGS. 2-7.

FIG. 8 and the description above are merely examples, and variations are contemplated to be within the scope of the present disclosure. In various embodiments, the operation may include other blocks not shown in FIG. 8. In various embodiments, any of the illustrated blocks may be performed in multiple blocks, which may be performed in a different order than as shown in FIG. 8. In various embodiments, any of the illustrated blocks may be combined into a combined block. Such and other variations are contemplated to be within the scope of the present disclosures.

FIG. 9 is a diagram of an example of an operation for identifying related portions of one or more documents based on representations of document sections.

Block 910 indicates one or more input document(s) to be processed to identify related portions of the document(s). In embodiments, various preprocessing may be performed on the documents. An example of preprocessing is text normalization. Normalizing a word is called text normalization, and it can involve several processes:
1. Lemmatization—Reducing a word to its base form (e.g., running→run).
2. Stemming—Cutting a word down to its root form (e.g., running→run).
3. Lowercasing—Converting all text to lowercase (e.g., AI→ai).
4. Removing Stopwords—Eliminating common words like “the”, “is”, “and”, etc.
5. Removing Punctuation & Special Characters, which cleans text for better processing.
   The above are merely examples of text normalization, and other forms of text normalization are contemplated to be within the scope of the present disclosure. Another example of preprocessing is language detection, which identifies and flags the language of the input text to ensure compatibility with the model.

Block 920 a machine learning model that is configured to receive the document(s) of block 910 and output identified document sections of the document(s). In various embodiments, the machine learning model may be a large language model, such as GPT-4o-mini, among other models. The machine learning model may identify any of a sentence, multiple sentences, a single paragraph, multiple paragraphs, a user defined document section, a page, multiple pages, a range of pages, an image, multiple images, a video, or multiple videos, among others, as a document section to be analyzed for relatedness to other document sections. In various embodiments, any links in the document may be accessed, and the content that is indicated by the link may be considered to be the document section. In various embodiments, any links in the document may be accessed, and the content that is indicated by the link may be processed to identify document sections in the linked document.

In aspects of the present disclosure, a user interface (e.g., FIG. 2, or otherwise) may include a user interface element (not shown) that allows a user to manually set what constitutes a document section. For example, a user may manually set a document section to be a single sentence, multiple sentences, a single paragraph, multiple paragraphs, a user defined document section, a range of pages, an image, multiple images, a video, or multiple videos, among others. The user interface element (not shown) may be a sliding bar in which one end sets a document section to be a single sentence, the other end sets a document section to be an entire document, and in between, the sliding bar can be set to multiple sentences, a paragraph, multiple paragraphs, a page, multiple pages, a page range, etc., to be a document section.

In embodiments, a machine learning model need not be used. A methodology for identifying document sections without machine learning is to search for new lines which indicate a new paragraph. In embodiments, rules can be used to discern if the new line is a paragraph by the number of words/characters, e.g., too few words may indicate that the text is a heading. For example, a document may include the text: “Chapter 1 \n It was a dark and stormy night”, where \n indicates a new line. Rules can indicate that such text should not be separated into two paragraphs. As another example, for text: “Two options: \n 1. One \n 2. Two”, such text should all be treated as one single paragraph. Such and other rules for identifying document sections without the use of machine learning model(s), or to supplement and/or cooperate with machine learning model(s), are contemplated to be within the scope of the present disclosure.

Block 930 indicates the document sections identified and output by the machine learning model of block 920. As mentioned above, a document section may be a sentence, multiple sentences, a single paragraph, multiple paragraphs, a user defined document section, a page, multiple pages, a range of pages, an image, multiple images, a video, or multiple videos, among others. In various embodiments, any links in the document may be accessed, and the content that is indicated by the link may be considered to be the document section.

Block 940 represents an operation that converts the document sections to representations, such as numerical vector representations or keyword representations, among others. Any text, image, or video may be converted to a vector representation or a keyword representations. In embodiments, an image or a video may be converted to a representations by generating text describing the image (e.g., by a machine learning model), and then generating the presentation based on the text describing the image or the video. In embodiments, an image or a video may be converted to a representations based on the metadata of the image or video.

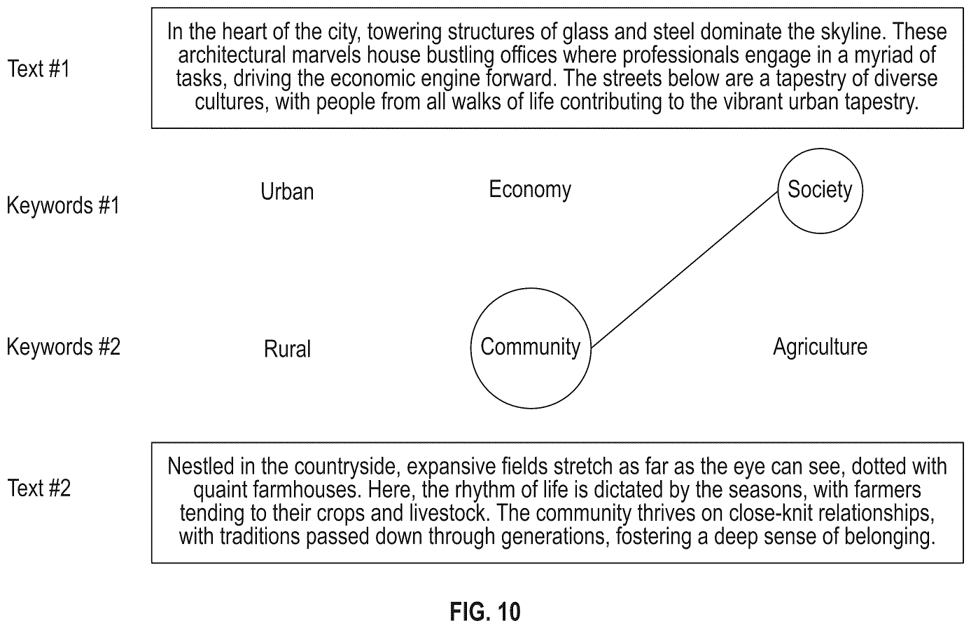

An example of keyword representation will be described in connection with FIG. 10.

An example of numerical vector representations may use word2vec to convert text to a vector. Persons skilled in the art will understand word2vec, which is described at: https://en.wikipedia.org/wiki/Word2vec, which is hereby incorporated by reference herein in its entirety. Other examples include large language models (LLM), such as BERT, GPT, or Sentence-BERT (SBERT), which persons skilled in the art will recognize. The LLM may be pre-trained on extensive corpora and generates contextualized embeddings for the document sections. Specifically, the LLM uses its deep neural network layers to process the text and extract semantic features. The final output is a fixed-size vector (embedding) for each document section. These embeddings are numerical representations capturing the semantic essence of the input text, considering context, syntax, and meaning. Such and other embodiments are contemplated to be within the scope of the present disclosure.

Block 950 represents an operation that processes the representations to determine relations among the representations. If the representations are keyword representations, similarity of the keywords (e.g., similarity in meaning) may be used to determine the relations between the keywords, which will be described in more detail in connection with FIG. 10. If the representations are vector representations, various approaches may be used to determine similarity between the vector representations. Examples include:
Attention Weights Analysis. Attention mechanisms to identify which words made the most impact.
Word Embedding Comparisons. By comparing individual word embeddings within the sentences, one can assess which words have similar representations. Aggregating these similarities can provide insights into the overall sentence similarity.
Model-Specific Interpretability Tools. For example Layer-wise Relevance Propagation (LRP). This technique can be applied to models like SBERT to trace back the contributions of each input feature (e.g., words or tokens) to the final similarity score, offering a detailed explanation of the model's decision-making process.
Cosine Similarity Calculation. Cosine similarity measures the cosine of the angle between the two vectors in the high-dimensional space. A value closer to 1 indicates high semantic similarity, while a value closer to 0 indicates low similarity.
Euclidean distance.
   Such and other embodiments are contemplated to be within the scope of the present disclosure.

Block 960 represents an operation that outputs, based on the relations identified at block 950, the related portions of the document(s) and labels/reasons for the relations.

Block 970 represents an operation that generates the user interface, such as, without limitation, any of the user interfaces of FIGS. 2-7.

FIG. 9 and the description above are merely examples, and variations are contemplated to be within the scope of the present disclosure. In various embodiments, the operation may include other blocks not shown in FIG. 9. In various embodiments, any of the illustrated blocks may be performed in multiple blocks, which may be performed in a different order than as shown in FIG. 9. In various embodiments, any of the illustrated blocks may be combined into a combined block. Such and other variations are contemplated to be within the scope of the present disclosures.

FIG. 10 is a diagram of an example of a keyword representation of text portions of a document, or of image or video portions of a document that are described by text or that have metadata. The operation of generating keyword representations of text portions of a document may be performed by, for example, block 940 of FIG. 9.

In the example of FIG. 10, text #1 is text of or corresponding to a first portion of a document, and text #2 is text of or corresponding to a second portion of the document. The keywords #1 are keyword in the keyword representation of text #1, and the keywords #2 are keyword representations of text #2. The keyword representations may be generated using, for example, a machine learning model (e.g., a large language model) that receives input text and can outputs keywords for the input text, such as GPT-4o-mini, among other possible models. An example of an input prompt to a GPT-4o-mini model and of an example output generated by such a model is described below in connection with FIG. 11. Such prompt and output are an example of identifying keywords for an input text. In various embodiments, the keywords may be words in the input text. In various embodiments, the keywords may be synonyms of words in the input text. In various embodiments, the keywords may be words that describe the input text but are not in the input text.

The operation of identifying relations among the representations may be performed by, e.g., block 950 of FIG. 9. In the illustrated example of FIG. 10, keywords #1 and keywords #2 do not include the same words. However, they include words that may have similar meanings, such as “society” in keywords #1 and “community” in keywords #2. Such relations may be determined using, e.g., using a database of words having similar meanings.

Accordingly, in the example of FIG. 10, the processing determines that text #1 and text #2 are related by the label/reason “society” and/or “community.”

FIG. 10 and the description above are merely examples, and variations are contemplated to be within the scope of the present disclosure.

FIG. 11 is a diagram of an example of an operation for identifying related portions of one or more documents using a machine learning model.

Block 1110 indicates one or more input document(s) to be processed to identify related portions of the document(s).

Block 1120 a machine learning model that is configured to receive the document(s) of block 910 and output related portions of the document(s) and labels/reason for the relations. In various embodiments, the machine learning model may be a large language model, such as the “gpt-4o mini” model, among other possibilities. The machine learning model may identify any types of document sections as being related, including, without limitation, a sentence, multiple sentences, a single paragraph, multiple paragraphs, a user defined document section, a page, multiple pages, a range of pages, an image, multiple images, a video, or multiple videos, among others, as being related. In various embodiments, any links in the document may be accessed, and the content that is indicated by the link may be considered to be the document section.

As an example, a prompt may be input to the LLM along with the document(s) to be processed. An example of a prompt may be:
Find me all the semantic connections between parts of these documents. Add also references to different sections. Organize in a table with the source and destination including the text of each and the page number. Add a column for the reasons why you thought there was a connection. Also add a column with 1-3 keywords which represent the common semantic information. If the connections are due to a reference to a section, write a hashtag with section which was referred to.

Based on such an input prompt, a truncated example of output of the LLM may be:

Here is the enhanced table, now including keywords representing the semantic connection and marking direct section references with a hashtag (#).

| Source | | | Destination | Destination | | Reason for | |
|---|---|---|---|---|---|---|---|
| Section | Source Text | Page | Section | Text | Page | Connection | Keywords |
| 1.2 | “Doc | 1 | 2.1 | “Semantic | 2 | The scope | semantic |
| Scope | Weaver is | | Product | Analysis: | | describes | analysis, |
| | designed to | | Features | The | | the | document |
| | assist users | | | application | | purpose, | comparison, |
| | in | | | will | | while | AI |
| | identifying | | | utilize | | product | |
| | semantic | | | state-of- | | features | |
| | similarities | | | the-art | | define how | |
| | and | | | language | | that | |
| | differences | | | models to | | purpose is | |
| | in textual | | | perform | | implemented. | |
| | content . . . ” | | | meaning- | | | |
| | | | | based | | | |
| | | | | comparisons | | | |
| | | | | of paragraphs | | | |
| | | | | and sections.” | | | |
| 2.1 | “Comparison | 2 | 2.2 User | “The | 3 | Content | redundancy |
| Product | Modes: | | Personas | Intra- | | editors | detection, |
| Features | Intra- | | (Content | document | | need intra- | consistency, |
| | document | | Editors) | Comparison | | document | intra- |
| | Comparison: | | | feature | | comparison, | document |
| | Identifies | | | (Section | | which is | #3.3 |
| | redundancies, | | | 3.3) | | listed as a | |
| | inconsistencies, | | | allows | | key | |
| | or | | | editors to | | feature. | |
| | duplicated | | | quickly | | | |
| | content | | | identify | | | |
| | within a | | | duplicate | | | |
| | single | | | or similar | | | |
| | document.” | | | content, | | | |
| | | | | streamlining | | | |
| | | | | their | | | |
| | | | | workflow.” | | | |
| 2.1 | “Inter- | 2 | 2.2 User | “The | 3 | Academic | plagiarism |
| Product | document | | Personas | Inter- | | researchers | detection, |
| Features | Comparison: | | (Academic | document | | need to | research, |
| | Highlights | | Researchers) | Comparison | | compare | inter- |
| | similarities | | | feature | | documents | document |
| | or | | | (Section | | for | #3.3 |
| | discrepancies | | | 3.3) | | plagiarism | |
| | between two | | | enables | | and | |
| | separate | | | researchers | | literature | |
| | documents.” | | | to compare | | review, | |
| | | | | their | | making | |
| | | | | drafts with | | inter- | |
| | | | | published | | document | |
| | | | | works or | | comparison | |
| | | | | reference | | relevant. | |
| | | | | materials | | | |
| | | | | effectively.” | | | |

(Example output, truncated for readability.)

This output shows:
Semantic connections between sections.
Reasons why the connection exists.
Keywords summarizing the connection.
Direct section references using hashtags (#).

Block 1130 represents the related portions of the document(s) and labels/reasons for the relations, output by the machine learning model of block 1120.

Block 1140 represents the user interface, such as, without limitation, any of the user interfaces of FIGS. 2-7.

FIG. 11 and the description above are merely examples, and variations are contemplated to be within the scope of the present disclosure. In various embodiments, the operation may include other blocks not shown in FIG. 11. In various embodiments, any of the illustrated blocks may be performed in multiple blocks, which may be performed in a different order than as shown in FIG. 11. In various embodiments, any of the illustrated blocks may be combined into a combined block. Such and other variations are contemplated to be within the scope of the present disclosures.

FIG. 12 is a block diagram of an example of components of a user device (e.g., 110, FIG. 1) or of a processing system (e.g., 120, FIG. 1). The components may be used to perform any of the operations or any aspects of the operations described herein, including the aspects and operations described in connection with any of FIGS. 1-11.

The computing components include an electronic storage 1210, a processor 1220, a memory 1240, and a network interface 1230. The various components may be communicatively coupled with each other. The processor 1220 may be and may include any type of processor, such as a single-core central processing unit (CPU), a multi-core CPU, a microprocessor, a digital signal processor (DSP), a System-on-Chip (SoC), or any other type of processor. The memory 1240 may be a volatile type of memory, e.g., RAM, or a non-volatile type of memory, e.g., NAND flash memory. The memory 1240 includes processor-readable instructions that are executable by the processor 1220 to cause the system to perform various operations, including those mentioned herein, such as the operations described in connection with of FIGS. 1-11.

The electronic storage 1210 may be and include any type of electronic storage used for storing data, such as hard disk drive, solid state drive, and/or optical disc, among other types of electronic storage. The electronic storage 1210 stores processor-readable instructions for causing the system to perform its operations and stores data associated with such operations, such as storing data relating to any of the information described herein in connection with FIGS. 1-11. The electronic storage 1210 may be a non-transitory processor readable medium. The network interface 1230 may implement networking technologies, such as Ethernet, Wi-Fi, and/or other wireless networking technologies.

The components shown in FIG. 12 are merely examples, and persons skilled in the art will understand that a system includes other components not illustrated and may include multiples of any of the illustrated components. Such and other embodiments are contemplated to be within the scope of the present disclosure.

The following section will describe further aspects of the present disclosure.

Example 1.1. A non-transitory processor-readable medium having stored thereon instructions which, when executed by at least one processor of an apparatus, cause the apparatus at least to perform:
accessing at least one document, the at least one document comprising at least one of: text, image, video, link to text, link to image, or link to video;
processing the at least one document to identify a plurality of relations between portions of the least one document, the processing comprising applying at least one machine learning model to the at least one document; and
generating a user interface configured to display the plurality of relations and to display corresponding portions of the at least one document corresponding to plurality of relations.

Example 1.2. The non-transitory processor-readable medium of Example 1.1,
wherein the plurality of relations comprise a first relation between a first corresponding portion of the at least one document and a second corresponding portion of the at least one document,
wherein the user interface is configured to display:
   the first corresponding portion of the at least one document,
   the second corresponding portion of the at least one document, and
   a first connection between the displayed first corresponding portion and the displayed second corresponding portion, the first connection corresponding to the first relation.

Example 1.3. The non-transitory processor-readable medium of Example 1.2,
wherein the user interface is configured to display a plurality of other document portions connected to the first corresponding portion,
wherein the plurality of other document portions have relations to the first corresponding portion that are different from the first relation.

Example 1.4. The non-transitory processor-readable medium of Example 1.2,
wherein the user interface is configured to display a plurality of other document portions connected to second corresponding portion,
wherein the plurality of other document portions have relations to the second corresponding portion that are different from the first relation.

Example 1.5. The non-transitory processor-readable medium of Example 1.2, wherein the user interface is further configured to display a first label indicating the first relation, the first label displayed adjacent to the displayed first connection.

Example 1.6. The non-transitory processor-readable medium of Example 1.5, wherein the user interface is further configured to display:
a third corresponding portion of the at least one document,
a fourth corresponding portion of the at least one document,
a second connection between the displayed first corresponding portion and the displayed third corresponding portion,
a third connection between the display second corresponding portion and the displayed fourth corresponding portion.

Example 1.7. The non-transitory processor-readable medium of Example 1.6, wherein a relation corresponding to the second connection is same as the first relation corresponding to the first connection.

Example 1.8. The non-transitory processor-readable medium of Example 1.6, wherein a second relation corresponding to the second connection is different from the first relation corresponding to the first connection.

Example 1.9. The non-transitory processor-readable medium of Example 1.8, wherein the user interface is further configured to display a second label indicating the second relation, the second label displayed adjacent to the second connection.

Example 1.10. The non-transitory processor-readable medium of Example 1.6, wherein a relation corresponding to the third connection is same as the first relation corresponding to the first connection.

Example 1.11. The non-transitory processor-readable medium of Example 1.6, wherein a second relation corresponding to the third connection is different from the first relation corresponding to the first connection.

Example 1.12. The non-transitory processor-readable medium of Example 1.11, wherein the user interface is further configured to display a second label indicating the second relation, the second label displayed adjacent to the third connection.

Example 1.13. The non-transitory processor-readable medium of Example 1.1, wherein the user interface further comprises at least one user interface element specifying at least one filter, wherein the at least one user interface element, when activated, causes the user interface to at least one of:
display only relations, among the plurality of relations, which match the at least one filter, or
display only relations, among the plurality of relations, which do not match the at least one filter.

Example 1.14. The non-transitory processor-readable medium of Example 1.13, wherein the at least one filter comprises at least one of:
a filter specifying a semantic relation category,
a filter specifying a referential relation category,
a filter specifying a hierarchical relation,
a filter specifying at least one section reference in the at least one document, or
a filter specifying a relation label.

Example 1.15. The non-transitory processor-readable medium of Example 1.13, wherein the at least one filter comprises at least one of:
a filter specifying a strength of a relation, or
a filter specifying number of occurrences of a relation.

Example 1.16. The non-transitory processor-readable medium of Example 1.15, wherein the filter specifying number of occurrences of a relation is provided by at least one of: a histogram user interface, or a heatmap user interface.

Example 1.17. The non-transitory processor-readable medium of Example 1.2, wherein the displayed first corresponding portion is selectable by a user,
wherein the instructions, when executed by at least one processor, further cause the apparatus at least to perform: in response to a user selecting the display first corresponding portion:
opening one document of the at least one document containing the first corresponding portion, and
displaying at least a portion of the one document showing the first corresponding portion.

Example 1.18. The non-transitory processor-readable medium of Example 1.1,
wherein the processing the at least one document to identify the plurality of relations between portions of the least one document comprises parsing the at least one document to identify document sections,
wherein the user interface further comprises at least one user interface element for a user to manually specify a granularity level for the document sections.

Example 1.19. The non-transitory processor-readable medium of Example 1.18,
wherein the parsing the at least one document to identify document sections comprises:
   identifying new lines in the at least one document; and
   identifying document sections based on the identified new lines and based on at least one rule specifying at least one criterion for whether or not a new line designates a new document section.

Example 1.20. The non-transitory processor-readable medium of Example 1.1, wherein the processing the at least one document to identify the plurality of relations between portions of the least one document comprises:
applying a first machine learning model to parse the at least one document to identify document sections.

Example 1.21. The non-transitory processor-readable medium of Example 1.20, wherein the machine learning model is a large language model.

Example 1.22. The non-transitory processor-readable medium of Example 1.20, wherein each of the document sections comprises at least one of:
a sentence, a single paragraph, multiple paragraphs, a user defined document section, a page, multiple pages, or a range of pages.

Example 1.23. The non-transitory processor-readable medium of Example 1.20, wherein the processing the at least one document to identify the plurality of relations between portions of the least one document further comprises:
converting each of the document sections into a respective representation; and
comparing the representations corresponding to the document sections to identify the plurality of relations between portions of the least one document.

Example 1.24. The non-transitory processor-readable medium of Example 1.23, wherein the representations comprise at least one of: numerical vector representations, or keyword representations.

Example 1.25. The non-transitory processor-readable medium of Example 1.19, wherein the converting each of the document sections into a respective representation comprises at least one of:
converting a document section comprising an image into a numerical vector representation,
converting a document section comprising a video into a numerical vector representation, or
converting a document section comprising text into a numerical vector representation.

Example 1.26. The non-transitory processor-readable medium of Example 1.25, wherein the comparing the representations corresponding to the document sections comprises comparing numerical vector representations based on a distance metric.

Example 1.27. The non-transitory processor-readable medium of Example 1.24, wherein the converting each of the document sections into a respective representation comprises:
converting a document section comprising text into a keyword representation.

Example 1.28. The non-transitory processor-readable medium of Example 1.27, wherein the comparing the representations corresponding to the document sections comprises comparing keyword representations based on at least one of the following:
exact keyword match, or
keyword synonym match.

Example 1.29. The non-transitory processor-readable medium of Example 1.17, wherein the processing the at least one document to identify the plurality of relations between portions of the least one document further comprises:
comparing the document sections using a second machine learning model to identify the plurality of relations between portions of the least one document.

Example 2.1. An apparatus comprising:
at least one processor;
at least one memory having stored thereon instructions which, when executed by the at least one processor, cause the apparatus at least to perform:
   accessing at least one document, the at least one document comprising at least one of: text, image, video, link to text, link to image, or link to video;
   processing the at least one document to identify a plurality of relations between portions of the least one document, the processing comprising applying at least one machine learning model to the at least one document; and
   generating a user interface configured to display the plurality of relations and to display corresponding portions of the at least one document corresponding to plurality of relations.

Example 2.2. The apparatus of Example 2.1,
wherein the plurality of relations comprise a first relation between a first corresponding portion of the at least one document and a second corresponding portion of the at least one document,
wherein the user interface is configured to display:
   the first corresponding portion of the at least one document,
   the second corresponding portion of the at least one document, and
   a first connection between the displayed first corresponding portion and the displayed second corresponding portion, the first connection corresponding to the first relation.

Example 2.3. The apparatus of Example 2.2,
wherein the user interface is configured to display a plurality of other document portions connected to the first corresponding portion,
wherein the plurality of other document portions have relations to the first corresponding portion that are different from the first relation.

Example 2.4. The apparatus of Example 2.2,
wherein the user interface is configured to display a plurality of other document portions connected to second corresponding portion,
wherein the plurality of other document portions have relations to the second corresponding portion that are different from the first relation.

Example 2.5. The apparatus of Example 2.2, wherein the user interface is further configured to display a first label indicating the first relation, the first label displayed adjacent to the displayed first connection.

Example 2.6. The apparatus of Example 2.5, wherein the user interface is further configured to display:
a third corresponding portion of the at least one document,
a fourth corresponding portion of the at least one document,
a second connection between the displayed first corresponding portion and the displayed third corresponding portion,
a third connection between the display second corresponding portion and the displayed fourth corresponding portion.

Example 2.7. The apparatus of Example 2.6, wherein a relation corresponding to the second connection is same as the first relation corresponding to the first connection.

Example 2.8. The apparatus of Example 2.6, wherein a second relation corresponding to the second connection is different from the first relation corresponding to the first connection.

Example 2.9. The apparatus of Example 2.8, wherein the user interface is further configured to display a second label indicating the second relation, the second label displayed adjacent to the second connection.

Example 2.10. The apparatus of Example 2.6, wherein a relation corresponding to the third connection is same as the first relation corresponding to the first connection.

Example 2.11. The apparatus of Example 2.6, wherein a second relation corresponding to the third connection is different from the first relation corresponding to the first connection.

Example 2.12. The apparatus of Example 2.11, wherein the user interface is further configured to display a second label indicating the second relation, the second label displayed adjacent to the third connection.

Example 2.13. The apparatus of Example 2.1, wherein the user interface further comprises at least one user interface element specifying at least one filter, wherein the at least one user interface element, when activated, causes the user interface to at least one of:
display only relations, among the plurality of relations, which match the at least one filter, or
display only relations, among the plurality of relations, which do not match the at least one filter.

Example 2.14. The apparatus of Example 2.13, wherein the at least one filter comprises at least one of:
a filter specifying a semantic relation category,
a filter specifying a referential relation category,
a filter specifying a hierarchical relation,
a filter specifying at least one section reference in the at least one document, or
a filter specifying a relation label.

Example 2.15. The apparatus of Example 2.13, wherein the at least one filter comprises at least one of:
a filter specifying a strength of a relation, or
a filter specifying number of occurrences of a relation.

Example 2.16. The apparatus of Example 2.15, wherein the filter specifying number of occurrences of a relation is provided by at least one of: a histogram user interface, or a heatmap user interface.

Example 2.17. The apparatus of Example 2.2, wherein the displayed first corresponding portion is selectable by a user,
wherein the instructions, when executed by at least one processor, further cause the apparatus at least to perform: in response to a user selecting the display first corresponding portion:
opening one document of the at least one document containing the first corresponding portion, and displaying at least a portion of the one document showing the first corresponding portion.

Example 2.18. The apparatus of Example 2.1,
wherein the processing the at least one document to identify the plurality of relations between portions of the least one document comprises parsing the at least one document to identify document sections,
wherein the user interface further comprises at least one user interface element for a user to manually specify a granularity level for the document sections.

Example 2.19. The apparatus of Example 2.18, wherein the parsing the at least one document to identify document sections comprises:
identifying new lines in the at least one document; and
identifying document sections based on the identified new lines and based on at least one rule specifying at least one criterion for whether or not a new line designates a new document section.

Example 2.20. The apparatus of Example 2.1, wherein the processing the at least one document to identify the plurality of relations between portions of the least one document comprises:
applying a first machine learning model to parse the at least one document to identify document sections.

Example 2.21. The apparatus of Example 2.20, wherein the machine learning model is a large language model.

Example 2.22. The apparatus of Example 2.20, wherein each of the document sections comprises at least one of:
a sentence, a single paragraph, multiple paragraphs, a user defined document section, a page, multiple pages, or a range of pages.

Example 2.23. The apparatus of Example 2.20, wherein the processing the at least one document to identify the plurality of relations between portions of the least one document further comprises:
converting each of the document sections into a respective representation; and
comparing the representations corresponding to the document sections to identify the plurality of relations between portions of the least one document.

Example 2.24. The apparatus of Example 2.23, wherein the representations comprise at least one of: numerical vector representations, or keyword representations.

Example 2.25. The apparatus of Example 2.19, wherein the converting each of the document sections into a respective representation comprises at least one of:
converting a document section comprising an image into a numerical vector representation,
converting a document section comprising a video into a numerical vector representation, or
converting a document section comprising text into a numerical vector representation.

Example 2.26. The apparatus of Example 2.25, wherein the comparing the representations corresponding to the document sections comprises comparing numerical vector representations based on a distance metric.

Example 2.27. The apparatus of Example 2.24, wherein the converting each of the document sections into a respective representation comprises:
converting a document section comprising text into a keyword representation.

Example 2.28. The apparatus of Example 2.27, wherein the comparing the representations corresponding to the document sections comprises comparing keyword representations based on at least one of the following:
exact keyword match, or
keyword synonym match.

Example 2.29. The apparatus of Example 2.17, wherein the processing the at least one document to identify the plurality of relations between portions of the least one document further comprises:
comparing the document sections using a second machine learning model to identify the plurality of relations between portions of the least one document.

The embodiments disclosed herein are examples of the disclosure and may be embodied in various forms. For instance, although certain embodiments herein are described as separate embodiments, each of the embodiments herein may be combined with one or more of the other embodiments herein. Specific structural and functional details disclosed herein are not to be interpreted as limiting, but as a basis for the claims and as a representative basis for teaching one skilled in the art to variously employ the present disclosure in virtually any appropriately detailed structure. Like reference numerals may refer to similar or identical elements throughout the description of the figures.

The phrases “in an embodiment,” “in embodiments,” “in various embodiments,” “in some embodiments,” or “in other embodiments” may each refer to one or more of the same or different embodiments in accordance with the present disclosure. A phrase in the form “A or B” means “(A), (B), or (A and B).” A phrase in the form “at least one of A, B, or C” means “(A); (B); (C); (A and B); (A and C); (B and C); or (A, B, and C).”

The systems, devices, and/or servers described herein may utilize one or more processors to receive various information and transform the received information to generate an output. The processors may include any type of computing device, computational circuit, or any type of controller or processing circuit capable of executing a series of instructions that are stored in a memory. The processor may include multiple processors and/or multicore central processing units (CPUs) and/or may include any type of device, such as a microprocessor, graphics processing unit (GPU), digital signal processor (DSP), neural processing unit (NPU), microcontroller, programmable logic device (PLD), field programmable gate array (FPGA), or the like. The processor may also include a memory to store data and/or instructions that, when executed by the one or more processors, causes the one or more processors to perform one or more methods and/or algorithms.

Any of the herein described methods, programs, algorithms or codes may be converted to, or expressed in, a programming language or computer program. The terms “programming language” and “computer program,” as used herein, each include any language used to specify instructions to a computer, and include (but is not limited to) the following languages and their derivatives: Assembler, Basic, Batch files, BCPL, C, C+, C++, Delphi, Fortran, Java, JavaScript, machine code, operating system command languages, Pascal, Perl, PL1, Python, scripting languages, Visual Basic, metalanguages which themselves specify programs, and all first, second, third, fourth, fifth, or further generation computer languages. Also included are database and other data schemas, and any other meta-languages. No distinction is made between languages which are interpreted, compiled, or use both compiled and interpreted approaches. No distinction is made between compiled and source versions of a program. Thus, reference to a program, where the programming language could exist in more than one state (such as source, compiled, object, or linked) is a reference to any and all such states. Reference to a program may encompass the actual instructions and/or the intent of those instructions.

It should be understood that the foregoing description is only illustrative of the present disclosure. Various alternatives and modifications can be devised by those skilled in the art without departing from the disclosure. Accordingly, the present disclosure is intended to embrace all such alternatives, modifications and variances. The embodiments described with reference to the attached drawing figures are presented only to demonstrate certain examples of the disclosure. Other elements, steps, methods, and techniques that are insubstantially different from those described above and/or in the appended claims are also intended to be within the scope of the disclosure.

What is claimed:

1. A processor-implemented method comprising:
accessing at least one document, the at least one document comprising at least one of: text, image, video, link to text, link to image, or link to video;
processing the at least one document to identify a plurality of relations between portions of the least one document, the processing comprising applying at least one machine learning model to the at least one document; and
generating a user interface configured to display the plurality of relations and to display corresponding portions of the at least one document corresponding to plurality of relations.

2. The processor-implemented method of claim 1,
wherein the plurality of relations comprise a first relation between a first corresponding portion of the at least one document and a second corresponding portion of the at least one document,
wherein the user interface is configured to display:
the first corresponding portion of the at least one document,
the second corresponding portion of the at least one document, and
a first connection between the displayed first corresponding portion and the displayed second corresponding portion, the first connection corresponding to the first relation.

3. The processor-implemented method of claim 2,
wherein the user interface is configured to display a plurality of other document portions connected to the first corresponding portion,
wherein the plurality of other document portions have relations to the first corresponding portion that are different from the first relation.

4. The processor-implemented method of claim 2,
wherein the user interface is configured to display a plurality of other document portions connected to second corresponding portion,
wherein the plurality of other document portions have relations to the second corresponding portion that are different from the first relation.

5. The processor-implemented method of claim 2, wherein the user interface is further configured to display a first label indicating the first relation, the first label displayed adjacent to the displayed first connection.

6. The processor-implemented method of claim 5, wherein the user interface is further configured to display:
a third corresponding portion of the at least one document,
a fourth corresponding portion of the at least one document,
a second connection between the displayed first corresponding portion and the displayed third corresponding portion,
a third connection between the display second corresponding portion and the displayed fourth corresponding portion.

7. The processor-implemented method of claim 6, wherein a relation corresponding to the second connection is same as the first relation corresponding to the first connection.

8. The processor-implemented method of claim 6, wherein a second relation corresponding to the second connection is different from the first relation corresponding to the first connection.

9. The processor-implemented method of claim 8, wherein the user interface is further configured to display a second label indicating the second relation, the second label displayed adjacent to the second connection.

10. The processor-implemented method of claim 6, wherein a relation corresponding to the third connection is same as the first relation corresponding to the first connection.

11. The processor-implemented method of claim 6, wherein a second relation corresponding to the third connection is different from the first relation corresponding to the first connection.

12. The processor-implemented method of claim 11, wherein the user interface is further configured to display a second label indicating the second relation, the second label displayed adjacent to the third connection.

13. The processor-implemented method of claim 1, wherein the user interface further comprises at least one user interface element specifying at least one filter, wherein the at least one user interface element, when activated, causes the user interface to at least one of:
display only relations, among the plurality of relations, which match the at least one filter, or
display only relations, among the plurality of relations, which do not match the at least one filter.

14. The processor-implemented method of claim 13, wherein the at least one filter comprises at least one of:
a filter specifying a semantic relation category,
a filter specifying a referential relation category,
a filter specifying a hierarchical relation,
a filter specifying at least one section reference in the at least one document, or
a filter specifying a relation label.

15. The processor-implemented method of claim 13, wherein the at least one filter comprises at least one of:
a filter specifying a strength of a relation, or
a filter specifying number of occurrences of a relation.

16. The processor-implemented method of claim 15, wherein the filter specifying number of occurrences of a relation is provided by at least one of: a histogram user interface, or a heatmap user interface.

17. The processor-implemented method of claim 2, wherein the displayed first corresponding portion is selectable by a user,
the processor-implemented method further comprising: in response to a user selecting the display first corresponding portion:
opening one document of the at least one document containing the first corresponding portion, and
displaying at least a portion of the one document showing the first corresponding portion.

18. The processor-implemented method of claim 1,
wherein the processing the at least one document to identify the plurality of relations between portions of the least one document comprises parsing the at least one document to identify document sections,
wherein the user interface further comprises at least one user interface element for a user to manually specify a granularity level for the document sections.

19. The processor-implemented method of claim 18, wherein the parsing the at least one document to identify document sections comprises:
identifying new lines in the at least one document; and
identifying document sections based on the identified new lines and based on at least one rule specifying at least one criterion for whether or not a new line designates a new document section.

20. The processor-implemented method of claim 1, wherein the processing the at least one document to identify the plurality of relations between portions of the least one document comprises:
applying a first machine learning model to parse the at least one document to identify document sections.

21. The processor-implemented method of claim 20, wherein the machine learning model is a large language model.

22. The processor-implemented method of claim 20, wherein each of the document sections comprises at least one of:
a sentence, a single paragraph, multiple paragraphs, a user defined document section, a page, multiple pages, or a range of pages.

23. The processor-implemented method of claim 20, wherein the processing the at least one document to identify the plurality of relations between portions of the least one document further comprises:
converting each of the document sections into a respective representation; and
comparing the representations corresponding to the document sections to identify the plurality of relations between portions of the least one document.

24. The processor-implemented method of claim 23, wherein the representations comprise at least one of: numerical vector representations, or keyword representations.

25. The processor-implemented method of claim 24, wherein the converting each of the document sections into a respective representation comprises at least one of:
converting a document section comprising an image into a numerical vector representation,
converting a document section comprising a video into a numerical vector representation, or
converting a document section comprising text into a numerical vector representation.

26. The processor-implemented method of claim 25, wherein the comparing the representations corresponding to the document sections comprises comparing numerical vector representations based on a distance metric.

27. The processor-implemented method of claim 24, wherein the converting each of the document sections into a respective representation comprises:
converting a document section comprising text into a keyword representation.

28. The processor-implemented method of claim 27, wherein the comparing the representations corresponding to the document sections comprises comparing keyword representations based on at least one of the following:
exact keyword match, or
keyword synonym match.

29. The processor-implemented method of claim 20, wherein the processing the at least one document to identify the plurality of relations between portions of the least one document further comprises:
comparing the document sections using a second machine learning model to identify the plurality of relations between portions of the least one document.
